(19) United States
(12) Patent Application Publication
(10) Pub. No.: US 2013/0199566 A1
(43) Pub. Date: Aug. 8, 2013

(54) METHOD AND DEVICE FOR CLEANING FILTERS

(71) Applicant: Jens Werner Kipp, Bielefeld (DE)

(72) Inventor: Jens Werner Kipp, Bielefeld (DE)

(21) Appl. No.: 13/638,948

(22) PCT Filed: Apr. 1, 2011
(86) PCT No.: PCT/EP2011/055110

§ 371 Date: Dec. 6, 2012

(30) Foreign Application Priority Data
Apr. 3, 2010 (DE) 10 2010 013 800.2
Apr. 22, 2010 (DE) 10 2010 017 834.9
Aug. 10, 2010 (DE) 10 2010 036 928.4
Sep. 10, 2010 (DE) 10 2010 044 929.6
Oct. 14, 2010 (DE) 10 2010 048 280.3
Nov. 22, 2010 (DE) 10 2010 060 716.9

(51) Int. Cl. B01D 41/04

(52) U.S. Cl. CPC B01D 41/04
USPC 134/7; 134/21; 134/144; 134/140

(57) ABSTRACT

The invention relates to a method for cleaning filters (22) which are designed as solid bodies having pores and/or having channels which are open towards the surface, by blasting using a blasting medium, characterised in that the blasting medium is gaseous and contains solid or liquid blasting agents, if appropriate in the form of substances having a boiling point of no more than 140° C., the blasting medium is accelerated in a jet nozzle (16, 18) so that it strikes the filter (22) at least at almost the speed of sound, and during blasting the filter (22) is disposed in front of an intake opening (34, 34′) which draws in the blasting medium as well as ambient air.

### Cross-Reference to Related Applications

This application is a National Stage United States application, claiming priority to earlier-filed PCT application number PCT/EP2011/055110, having a filing date of Apr. 1, 2011, now published as WO 2011/121114 A2.

### FIELD OF THE INVENTION

The invention relates to a method for cleaning filters, which are designed as solid bodies having pores and/or having channels which are open towards the surface, by blasting using a blasting medium, as well as a device for carrying out this method.

### BACKGROUND OF THE INVENTION

In particular, the invention concerns cleaning of particle filters, e. g. exhaust gas filters for diesel generator sets of automobiles, ships and the like. To extend the useful life of such filters and by still meeting the relevant admission standards, these highly stressed filters should be dismounted from time to time and should be cleaned by blasting and regenerated. So far, for this purpose usually a high-pressure cleaner is used, with which the filter is blasted with water. However, the resulting high environmental pollution are disadvantageous, namely the formation of large amounts of water polluted with contaminants. Since the pollutants coming off the filter slosh back as dust or mud, the conventional method is associated with a high health burden for the personnel. Furthermore, it is also known to burn the pollutants at high temperatures and to blow-out the ashes with compressed air. Both known methods have the disadvantage that they derogate the catalytic characteristics of the filter.

### SUMMARY OF THE INVENTION

It is the object of the present invention to provide a method, which enables an efficient and gentle cleaning of the filter with reduced environmental and health burden.

This object is solved in that
the blasting medium is gaseous and includes solid or liquid blasting agent at the most in the form of substances, whose main component has a boiling point of no more than 140° C.,
the blasting medium is accelerated in a jet nozzle so that it strikes the filter at least nearly the speed of sound, and
the filter is disposed in front of a suction opening, which draws in the blasting medium as well as ambient air.

As the blasting medium, a gas is used, e.g. compressed air or nitrogen, which either contains no solid or liquid blasting agents or in which fine droplets or particles of a highly volatile substance as blasting agent are suspended. Little admixtures of less volatile substances having a boiling point of more than 140° C., are not generally excluded, however the blasting medium preferably contains only substances whose boiling point is no more than 140° C. This blasting medium can be accelerated up to the speed of sound or the speed of ultrasound with a suitable jet nozzle, e.g. a laval nozzle. Thereby, an especially intensive and still gentle cleaning efficiency is achieved and the jet deeply penetrates the pores and channels of the filter, so that the cleaning effect is not limited to the surface. Via the intake opening not only the blasting medium is exhausted, but also ambient air is aspirated. This ensures an effective evacuation of pollutants and prevents these pollutants from being emitted into the environment in an uncontrolled way.

Moreover, the subject-matter of the invention includes a device, which is suitable for carrying out this method.

Preferable embodiments and arrangements of the invention are given in the sub-claims.

Preferably the blasting medium and the mixture of the blasting medium and the blasting agent, respectively, has a mean temperature of less than 0° C. when leaving the jet nozzle.

By the low temperature of the blasting medium, a brittleness effect is achieved, which benefits the separation of the pollutants from the filter material.

In one embodiment the blasting medium is nitrogen gas, which derives from decompression of liquid nitrogen and which therefore has a lower temperature.

In a particularly preferred embodiment the low temperature is achieved using dry ice or dry snow as blasting agent which is added to the gaseous blasting medium (e.g. compressed air). A jet nozzle, in which the dry ice is produced in situ by decompression of liquid CO₂ is particularly advantageous. An example of such a jet nozzle is described in EP 1 501 655 B1.

For effectively exhausting the blasting agent and the pollutants, in particular referring to closed filter systems having filters, which are open only at their ends, it is advantageous if the suction nozzle is directly applied on an open end. The suction nozzle then should preferably generate an negative pressure of at least 1 kPa (0.01 bar) and further preferably at least 5 or 10 kPa.

For filters with porous filter material the blasting agent should further be pore-penetrable in that it quickly vaporizes or sublimates when striking the filter material and can then be exhausted through the pores, and/or in that the particles of the blasting agent are so small (or get so small by vaporization or sublimation), that they pass the pores. If dry snow is used as blasting agent, which is generated by means of a jet nozzle according to EP 1 501 655 B1, the amount of dry snow blasted in and the dimension of the dry snow particles can be controlled in that the pressure of the compressed air and the flow of liquid CO₂ is suitably adjusted and/or by a suitable design and dimensioning of the decompression room, in which the liquid CO₂ decompresses. Examples for this purpose are also given in EP 1 765 551 B1 and WO 2005/005377 A1. Generally, the process parameters should be selected in that the amount of blasting agent, which is applied from the nozzle per time unit is smaller than the amount of blasting agent, which passes through the pores of the filter material per time unit or which can be ejected on the blasting-in side by the gas flow. By this it is prevented that the blasting agent blocks the filter.

According to another aspect of the invention, the blasting medium can also be compressed air to which a liquid, e.g. water, is added as blasting agent. The water is nebulized to fine droplets, which are accelerated in the nozzle to a high speed, so that a corresponding high cleaning effect is achieved. However, the used amount of water having the same or a higher cleaning effect is clearly smaller as referring to common blasting with a high-pressure cleaner, and therefore lower costs for the disposal of waste-water are caused.

By means of a manipulator system, a relative movement between the jet nozzle and the filter is generated, so that the jet can be focussed on all desired surface portions of the filter. The course of movement is controlled on the basis of the geometry and the composition of the filter to be cleaned.

Exhaust gas particle filters usually have a substantially cylindrical form. For high quality steel filters the lateral surface of the cylinder is interrupted by channels. The manipulator system can be designed such that the filter can be rotated around its longitudinal axis and can be moved simultaneously in the axial direction relative to the stationary nozzle. When the filter has the form of a hollow cylinder, a cleaning can also be carried out from the inner circumferential surface.

Other filter types, e.g. the most ceramic filters, comprise a lateral surface, which is not interrupted, and gas channels run from the two end faces of the filter axially to the inside of the filter body, where the gas channels entering from opposite end faces, overlap each other, however usually keep separate from each other by the walls of the porous ceramic material. For cleaning such filters, the manipulator system can have at least a radially movable nozzle, which faces the local end face. By superimposition of the radial movement of the nozzle with the rotation of the filter around its longitudinal axis, the whole end face can be cleaned, whereby the jet of the blasting medium, which is accelerated to a high speed, can deeply penetrate into the gas channels. When a nozzle is only arranged on one end of the filter, the manipulator system can be designed in that the filter is rotated by 180° around the cross-axis, to clean the opposite end face.

Of course, manipulator systems are also possible, where only the nozzle is moved relative to the stationary filter.

Preferably the manipulator system comprises a programmable control unit, with which the course of movement can be programmed. In this control unit several programs for different filter types can be stored, so that it is adequate to input the corresponding filter type or a few characterizing parameters of the filter, that the cleaning process can incidentally run automatically. Alternatively, the control unit may also offer the possibility to vary the speed of the courses of movement and thereby also the duration and the intensity of the cleaning process according to the degree of pollution or the material consistency of the filter.

Examples of the invention are described in detail on the basis of the drawings.

### BRIEF DESCRIPTION OF THE DRAWINGS

It is shown:

FIG. 1 a schematic axial section through a device for carrying out the method according to the invention;

FIG. 2 a device according to FIG. 1 in a schematic cross-section;

FIG. 3 an axial section through the device according to a modified embodiment;

FIG. 4 a sketch of a device according to a further embodiment;

FIG. 5 a modified embodiment of the device according to FIG. 4; and

FIG. 6 an enlarged section-view of a portion of a ceramic filter.

### DETAILED DESCRIPTION

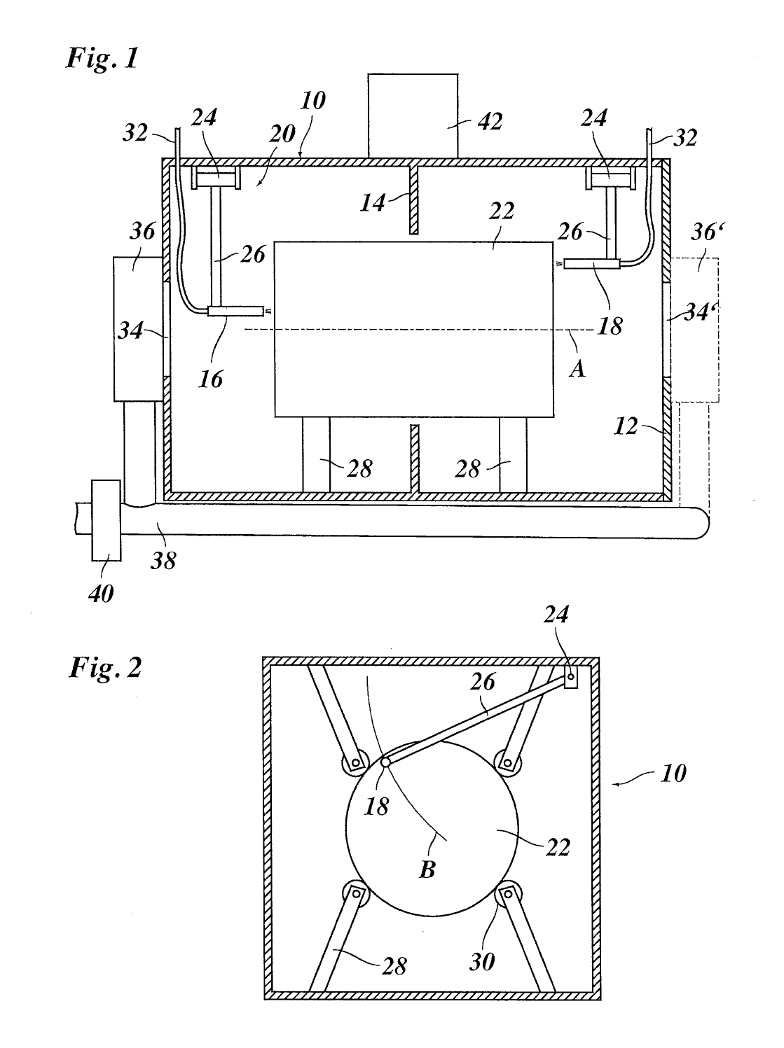

In FIG. 1 a block-shaped casing 10 is shown, which comprises a flap 12 at one end and which is divided by a divider wall 14 in two partitions inside. In the inside of the casing 10 in the shown example two jet nozzles 16, 18 and a manipulator system 20 are arranged, which allows to hold a filter 22 of substantially cylindrical form, e. g. a ceramic filter having a closed lateral surface and to move the filter and the jet nozzles relative to each other.

The manipulator system 20 comprises pivot drives 24 for the jet nozzle 16 and 18, which are held at pivotable arms 26.

The filter 22 is supported on two sets of bearing blocks 28, such that every end of the filter lies in one of the partitions of the casing. As FIG. 2 shows, every set comprises four pivotable or extendable and retractable bearing blocks 28, which support a roll 30 on their free end, respectively. The rolls 30 abut against the lateral surfaces of the cylindrical filter 22 and thereby hold the filter 22 solidly in its position. At least one of the rolls 30 is rotatably drivable, so that a rotary drive is formed, which is part of the manipulator system and with which the filter 22 can rotate around its longitudinal axis A (FIG. 1).

The jet nozzles 16 and 18 face the opposite end faces of the cylindrical filter 22. As FIG. 2 shows, the arms 26 can be pivoted by means of the pivot drives 24 so that the jet nozzle (e.g. the jet nozzle 18 in FIG. 2) moves in such a way on a circular arc B that the radial position of the jet nozzle can be varied. In the shown example, the circular arc B runs through the axis A of the filter, so that also the centre of the end face of the filter 22 can be reached. By the combination of the pivot movements of the arms 24 with the rotation of the filter 22 the complete end faces of the filter 22 can be blasted.

For adaption to filters having different dimensions, the axial positions of the jet nozzles 16 and 18 can be adjustable, either motor-driven or manually, if necessary.

The jet nozzles 16 and 18 are designed as laval nozzles, respectively and are connected via flexible pipes 32 with a not-shown compressed air source, which is arranged outside of the casing 10 and with a source for liquid CO₂. The jet nozzles are e.g. configured as described in EP 1 501 655 B. The liquid CO₂ is decompressed in the jet nozzle in a decompression room, so that a part of the CO₂ vaporizes and the resulting evaporative cooling with the result that another part of the CO₂ condenses out to dry snow particles. The latter are then carried from the compressed air flow to the laval nozzle, where the compressed air and the CO₂ particles are accelerated to the speed of ultrasound. In this manner, an energy-rich jet is created, which strikes the surface of the filter 22 and deeply penetrates into the local pores and/or channels. The CO₂ particles do thereby not only unfold a mechanical effect, but also lead to a strong cooling of the filter material and thus to an embrittlement, which benefits the removal of pollutants. At last, the particles again vaporize to gaseous CO₂, which ensures the evacuation of the separated pollutants together with the compressed air.

In the flap 12 and in the opposite wall of the casing 10 suction openings 34, 34′ are provided. In the state shown in FIG. 1, a suction chamber 36, which is connected via an suction line and a dust arrester 40 to a not-shown suction blower, is pivoted in such a way in front of the left suction opening 34 that air is exhausted from the corresponding partition of the casing. By the other suction opening 34′ in the meantime air can enter into the other partition of the casing. The divider wall 14 forces the air to flow through the filter 22.

When cleaning a filter 22 with the above described device, first the clap 12 is opened and the filter is clamped in the position shown in FIG. 1. The arms 26 thereby are pivoted in a position in which they plainly lie under the ceiling of the casing 10, so that they are out of the way during the insertion of the filter. Afterwards the clap 12 is closed, the suction chamber 36 is pivoted in front of the suction opening 34 and the jet nozzle 18, the manipulator system 20 and the exhaustion are set into operation. In this manner, first the right end face of the filter 22 is cleaned. Thereby the casing and in particular the filter 22 is flushed by an airflow, which has the same direction as the jet emitted by the jet nozzle 18 and the pollutants, which are removed from the filter 22 are exhausted from the inside of the casing together with the gaseous CO₂. The pollutants are deposited in the dust arrester 40 and are collected. The mixture of air and CO₂, which is exhausted from the suction blower, can be removed to the environment without hesitation.

Afterwards a suction chamber 36′, which is also connected to the suction tube 38, is pivoted in front of the suction opening 34′, while the suction chamber 36 is pivoted away from the suction opening 24, so that the air now flows in the opposite direction through the filter 22. By means of the manipulator system 20, now the jet nozzle 16 is moved over the left end face of the filter for cleaning it, too.

The manipulator system and if applicable also the feeding systems for compressed air and CO₂ to the jet nozzles are connected to a programmable electronic control unit 42, which controls the courses of movement, i.e. the rotation of the filter 22 around the axis A in the shown example and the movements of the jet nozzles 16, 18 in the desired manner. If appropriate also the jet nozzles are turned on and turned off as required by means of the control unit 42. Also the suction blower can be controlled by the control unit 42 in such a way that the exhaustion always takes place when the jet nozzles are in operation. For avoiding re-contamination on the filter, the exhaustion should be configured to an air change (at least substantial or near complete air exchange), which corresponds at least to the—times per minute, preferably at least to the 10-times, further preferably at least to the 100-times of the volume of the filter 22.

In the control unit 42 different programs for different types and/or different dimensions of the filter 22 can be stored. So the user just has to input the type and/or the dimensions of the filters to be cleaned to a control panel of the control unit 44, and the whole cleaning procedure then runs automatically. Also the speed with which the jet nozzles 16, 18 move with respect to the filter 22 can be varied by means of the control unit 42, so that the intensity and the duration of the cleaning procedure can be adapted to the respective degree of pollution and/or the material consistence of the filter.

In another embodiment the jet nozzle 16 and the suction chamber 36′ may be omitted. After cleaning the right end face of the filter, the flap 12 is closed preliminarily and the filter 20 is turned around, so that the other end face can be cleaned with the jet nozzle 18.

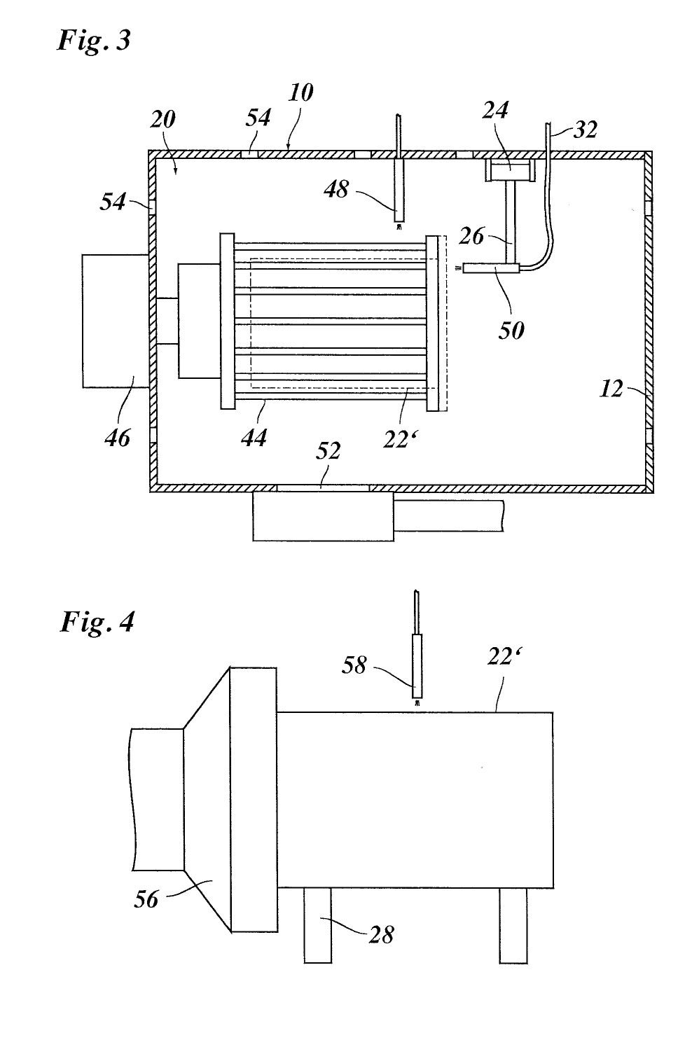

In FIG. 3 a modified embodiment of the device according to the invention is shown with which e.g. high quality steel filters 22′ can be cleaned, which have an interrupted lateral surface. The manipulator system 20 in this case comprises a cage 44 at which the filter can attach to a flange with one end in such a way that it is accommodated and held in the cage. A drive 46 allows to rotate the cage and thereby the filter 22 around its longitudinal axis and to shift it in an axial direction.

A stationary jet nozzle 48 blasts through the wall of the cage 44 onto the lateral surface of the filter for cleaning it. For the case that also an end face of the filter 22′ has to be cleaned, a pivotable jet nozzle 50 is provided on one end, which is on the opposite side to the drive 46, and which works as the jet nozzle 18 in FIG. 1 and which is pivoted in front of the end face of the filter while the cage 44 is held at its rightmost position.

In this case a suction opening 52 is integrated in the bottom of the casing 10 and is attached to a corresponding suction system. In the walls of the casing 10 air inlet openings 54 are provided.

FIG. 4 shows an embodiment, in which, similar as in FIG. 1, the filter 22′ is supported on bearing blocks 28 and is directly attached to a suction opening 56 of a suction device with one end face, so that the air can be exhausted directly from the inside of the filter. In this case a jet nozzle 58 is moved by means of a robotic arm, for blasting the circumferential surface and the other end face of the filter.

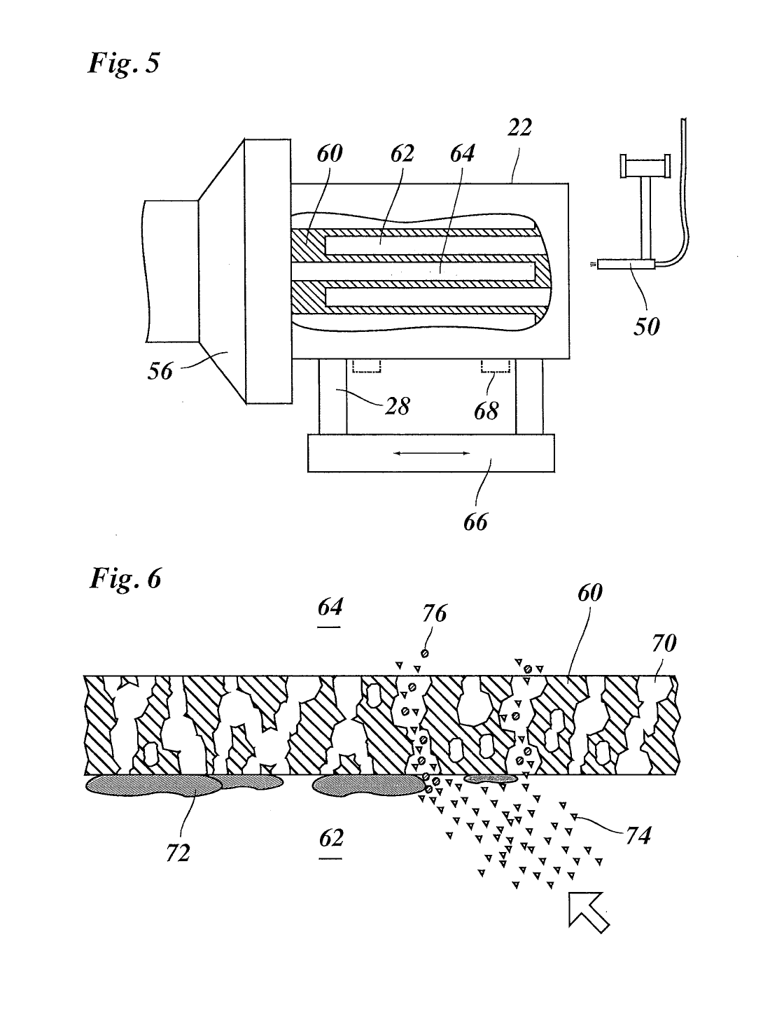

FIG. 5 shows an embodiment, which is similar to the embodiment of FIG. 4, which is, however, provided especially for the case that the filter 22 is a ceramic filter. The filter substantially consists of a porous ceramic material 60, in which bores 62, 64 enter from opposite end faces of the filter, and engage to each other in the inside of the filter in a comb-like manner and which are separated from each other only by relatively thin walls of the ceramic material 60.

With the nozzle 50, which has already been described referring to FIG. 5, the compressed air and the blasting agent are blown in from the end surface of the filter into the bores 62. The suction opening 56 is attached to the opposite end face of the filter and generates an negative pressure of at least 1 kPa, preferably at least 10 kPa, further preferably 50 kPa or more, so that the blasting agent and the pollutants, which are removed from the filter, are efficiently exhausted through the bores 64.

The bearing blocks 28 are arranged on a carriage 66, which is movable in the axial direction of the filter 22. When the nozzle 50 has carried out a pivot movement over the end face of the filter, the carriage 66 is moved back, so that the filter 22 comes clear from the suction nozzle 56 and then can be rotated around its longitudinal axis. If necessary, the filter 22 can be fixed with tie-members, which are guided over the circumference of the filter, rotatably but axially fixed on the bearing blocks 28. After the filter was rotated around a certain angle, it is again moved against the suction opening and the nozzle 50 is again operated. In this manner, the whole end surface of the filter 22 can be stepwise swept with the nozzle 50. Afterwards the filter is lifted off from the bearing blocks 28 with a handling system, which e.g. comprises two parallel arms 68 and works as a lift-truck, and is moved out of the device in the direction perpendicular to the plane of projection in FIG. 5. The filter is then rotated and is again moved into the device in the opposite orientation, so that also the opposite end face is cleaned correspondingly.

In FIG. 6 a schematically enlarged section of the ceramic material 60 is shown, which separates one of the bores 62 from an adjacent bore 64. The filter material has an open cell pore structure with pores 70, which pass through from the bore 62 to the bore 64. The pore diameter lies e.g. in the dimension of about 1 μm, so that particles with a diameter of more than 1 μm are held back by the filter. The held back pollutants form a coat 72 at the walls of the bores 62, which blocks part of the pores 70.

The blasting agent, which is ejected from the nozzle 50, in the shown example consists of particles 74 of dry snow, which either were generated by decompression of liquid CO₂ or by breaking solid CO₂. The particles 74 are blown into the bores 64 from the nozzle 50 with at least nearly the speed of sound and strike the walls of this bore with a high speed, as indicated in FIG. 6 by an arrow. By the striking particles 74 of the blasting agent the coat 72 is broken and small broken bits 76 are generated, which are exhausted through the pores 70 because of the negative pressure which is present in the bore 64 or which are ejected to the open side of the bore together with the compressed air, which is swirled in the bore. Also the particles 74 of the blasting agent are smaller than the pores 70, so that they are also exhausted through these pores, namely with a sufficient high mass-flow rate, so that the blasting agent, which is supplied by the nozzle 50 does not collect in the bore 62 and does not block it. If applicable, the particles 74 may initially have a diameter which is larger than the pore diameter. Since the dry snow particles are broken-up when striking the filter material 60 in parts and are heated partially and sublimate, the particle diameter is reduced so far and/or the particles are deformed, that they can pass through the pores. If applicable, the particles may also vaporize completely. The gaseous CO₂, which is generated in this manner, accounts for flushing out the fragments 76 of the coat 72 from the pores 70. In this manner a lasting but still gentle cleaning of the filter 20 can be achieved.

1-15. (canceled)

16. Method for cleaning filters, the filters designed as solid bodies having pores and/or channels, which are open towards the surface, the cleaning performed by blasting using a blasting medium, characterized in that
the blasting medium is gaseous and contains a solid or liquid blasting agent, if appropriate, in the form of substances having a boiling point of no more than 140° C.,
the blasting medium is accelerated in a jet nozzle so that it strikes the filter at least nearly the speed of sound, and
during blasting, the filter is arranged in front of a suction opening, which draws in the blasting medium as well as ambient air.

17. Method according to claim 16, wherein the filter is mounted in a casing, which at least contains a jet nozzle and a manipulator system and in which wall a suction opening is arranged.

18. Method according to claim 16, wherein the filter is directly attached to the suction opening.

19. Method according to claim 16, wherein the blasting agent is dry snow.

20. Method according to claim 16, wherein the volume flow through the suction opening per minute corresponds at least to the three-fold volume of the filter.

21. Method according to claim 16, wherein the blasting agent is exhausted with an negative pressure of at least 1 kPa from the pores of the filter.

22. Method according to claim 16, wherein the mean diameter of the Particles of the blasting agent in relation to the diameter of the pores of the filter and the applied amount of blasting agent is configured and controlled such that the blasting agent is conducted as fast as it is supplied by the jet nozzle.

23. Method according to claim 16, wherein the blasting medium is a gas, to which a liquid is added as blasting agent.

24. Method for cleaning filters, which are designed as solid bodies having pores and/or channels which are open to the surface, the cleaning performed by blasting using a blasting medium, characterized in that the blasting agent is a gas, to which a liquid is added as blasting agent.

25. Method according to claim 24, wherein the blasting medium and the mixture of blasting medium and blasting agent, respectively, has a mean temperature of less than 0° C. when leaving the jet nozzle.

26. Device for carrying out the method according to claim 16, characterized by at least one jet nozzle, a manipulator system for moving the filter and the at least one jet nozzle relative to each other, and a suction system for exhausting the blasting agent.

27. Device according to claim 26, having a casing, which contains the at least one jet nozzle and the manipulator system and to which the suction system is attached.

28. Device according to claim 26, wherein the manipulator system comprises a rotation drive for rotating the filter around its longitudinal axis (A).

29. Device according to claim 26, wherein the manipulator system comprises a drive for moving the filter in its axial direction.

30. Device according to claim 26, wherein the manipulator system comprises at least one arm, which has a jet nozzle at the free end and which is pivotable by means of a pivoting drive around an axis, which is parallel to the axis (A) of the filter.

31. Device for carrying out the method according to claim 24, characterized by at least one jet nozzle, a manipulator system for moving the filter and the at least one jet nozzle relative to each other, and a suction system for exhausting the blasting agent.
